(19) United States
(12) Patent Application Publication
(10) Pub. No.: US 2026/0268645 A1
(43) Pub. Date: Sep. 10, 2026

(54) NON-TRANSITORY COMPUTER READABLE MEDIUM, IMAGE ANALYSIS METHOD, AND IMAGE ANALYSIS DEVICE

(71) Applicant: Yokogawa Electric Corporation, Tokyo (JP)

(72) Inventors: Yu Kohase, Tokyo (JP); Tomoya Ito, Tokyo (JP)

(73) Assignee: Yokogawa Electric Corporation, Tokyo (JP)

(21) Appl. No.: 19/553,828

(22) Filed: Mar. 2, 2026

(30) Foreign Application Priority Data
Mar. 5, 2025 (JP) 2025-034915

(51) Int. Cl. G06V 10/776; G06V 10/40

(52) U.S. Cl. CPC G06V 10/776; G06V 10/40

(57) ABSTRACT

A non-transitory computer readable medium stores an image analysis program. The image analysis program is configured to cause a processor to estimate at least one of the number and the size of an object as an attribute of the object from a first image in which the object appears, evaluate an estimation result of the attribute of the object based on prior information on the object, and record or tally the estimation result when the estimation result is evaluated as valid.

### CROSS REFERENCE TO RELATED APPLICATION

The present application claims priority to Japanese Patent Application 2025-034915 filed on Mar. 5, 2025, the entire contents of which are incorporated herein by reference.

### TECHNICAL FIELD

The present disclosure relates to a non-transitory computer readable medium, an image analysis method, and an image analysis device.

### BACKGROUND

As described in Patent Literature (PTL) 1, a device that determines the number of cells present in a microscopic image using a trained model is known.

### Citation List

### Patent Literature

PTL 1: JP 2019-076063 A

### SUMMARY

A non-transitory computer readable medium according to several embodiments stores an image analysis program. The image analysis program is configured to cause a processor to estimate at least one of a number and a size of an object as an attribute of the object from a first image in which the object appears, evaluate an estimation result of the attribute of the object based on prior information on the object, and record or tally the estimation result when the estimation result is evaluated as valid.

An image analysis method according to several embodiments includes a processor estimating at least one of a number and a size of an object as an attribute of the object from a first image in which the object appears, evaluating an estimation result of the attribute of the object based on prior information on the object, and recording or tallying the estimation result when the estimation result is evaluated as valid.

An image analysis device according to several embodiments includes an estimator configured to estimate at least one of a number and a size of an object as an attribute of the object from a first image in which the object appears, and an evaluator configured to evaluate an estimation result of the attribute of the object based on prior information on the object, and record or tally the estimation result when the estimation result is evaluated as valid.

### BRIEF DESCRIPTION OF THE DRAWINGS

In the accompanying drawings:

FIG. 1 is a block diagram illustrating an example configuration of an image analysis device according to a comparative example;

FIG. 2 is a block diagram illustrating an example configuration of an image analysis system according to the present disclosure;

FIG. 3 is a flowchart illustrating an example of procedures of an image analysis method according to the present disclosure;

FIG. 4 is a diagram illustrating an example image of an object;

FIG. 5 is a block diagram illustrating an example configuration of an image analysis device according to another embodiment; and

FIG. 6 is a flowchart illustrating an example of the procedures of an image analysis method according to another embodiment.

### DETAILED DESCRIPTION

When using a trained model to discriminate objects in an image, incorrect discrimination results may be obtained. An incorrection in the discrimination results reduces the accuracy of analysis of the number, size, or the like of objects appearing in the image. Demand exists for improving the accuracy of analyzing objects appearing in images. The non-transitory computer readable medium, image analysis method, and image analysis device according to the present disclosure can improve the accuracy of analyzing objects appearing in an image.
(1) A non-transitory computer readable medium according to several embodiments stores an image analysis program. The image analysis program according to several embodiments is configured to cause a processor to estimate at least one of a number and a size of an object as an attribute of the object from a first image in which the object appears, evaluate an estimation result of the attribute of the object based on prior information on the object, and record or tally the estimation result when the estimation result is evaluated as valid. In this way, even if the estimation model erroneously detects an object from an image or erroneously estimates the attributes of an object appearing in the image, the erroneous estimation result is excluded from recording or tallying. By eliminating erroneous estimation results, the accuracy of analysis of an object appearing in the image is improved.
(2) The image analysis program stored in the non-transitory computer readable medium according to (1) may cause the processor to re-estimate the attribute of the object from the first image in a case in which the estimation result of the attribute of the object appearing in the first image is evaluated as invalid, and record or tally a re-estimation result.
(3) The image analysis program stored in the non-transitory computer readable medium according to (1) or (2) may cause the processor, in a case in which the estimation result of the attribute of the object appearing in the first image is evaluated as invalid, to estimate the attribute of the object from a spare second image that can replace the first image. With this configuration, even if the estimation results of the attributes of objects appearing in some images captured for a single sample are evaluated as invalid, compensation is made for the lack of images required for recording or tallying the estimation results of the attributes of objects contained in a single sample. As a result, the accuracy of recording or tallying the estimation results of the attributes of the objects contained in the sample is improved.
(4) In the image analysis program stored in the non-transitory computer readable medium according to any one of (1) to (3), the prior information on the object may include information regarding a shape or the size of the object. By including information regarding the size of the object in the prior information, the accuracy of evaluating the validity of the estimation result of the size of the object is improved. By including information regarding the shape of the object in the prior information, the accuracy of detecting the object from the image is improved. As a result, the accuracy of analyzing the objects in the image is improved.
(5) In the image analysis program stored in the non-transitory computer readable medium according to any one of (1) to (4), in a case in which the object is an aggregate including aggregate elements, the prior information on the object may include a ratio between a size of the aggregate and a number of the aggregate elements, or a ratio between a size of the first image and the number of the aggregate elements. By the prior information including information regarding the number of aggregate elements, the accuracy of estimating the number of objects appearing in the image is improved. As a result, the accuracy of analyzing the objects in the image is improved.
(6) The image analysis program stored in the non-transitory computer readable medium according to any one of (1) to (5) may cause the processor to further estimate at least one of a color or a texture of the object as an attribute of the object from the first image. This improves the accuracy of detecting individual aggregate elements in an aggregate.
(7) In the image analysis program stored in the non-transitory computer readable medium according to any one of (1) to (6), the prior information on the object may include information regarding the color or the texture of the object. By the prior information including information regarding the color or texture of the object, the accuracy of detecting an object from an image is improved. As a result, the accuracy of analyzing the objects in the image is improved.
(8) An image analysis method according to several embodiments includes a processor estimating at least one of a number and a size of an object as an attribute of the object from a first image in which the object appears, evaluating an estimation result of the attribute of the object based on prior information on the object, and recording or tallying the estimation result when the estimation result is evaluated as valid.
(9) An image analysis device according to several embodiments includes an estimator configured to estimate at least one of a number and a size of an object as an attribute of the object from a first image in which the object appears, and an evaluator configured to evaluate an estimation result of the attribute of the object based on prior information on the object, and record or tally the estimation result when the estimation result is evaluated as valid.
(10) The image analysis device according to (9) may further include a re-estimator configured to re-estimate the attribute of the object from the first image in a case in which the estimation result of the attribute of the object appearing in the first image is evaluated as invalid, and record or tally a re-estimation result.
(11) In the image analysis device according to (9) or (10), in a case in which the estimation result of the attribute of the object appearing in the first image is evaluated as invalid, the estimator may estimate the attribute of the object from a spare second image that can replace the first image.

### Comparative Example

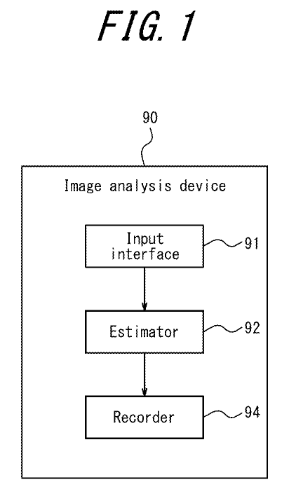

As illustrated in FIG. 1, an image analysis device 90 according to the comparative example includes an input interface 91, an estimator 92, and a recorder 94. The input interface 91 receives input of an image in which an object of image analysis appears. The estimator 92 analyzes the image using a trained model generated by performing deep learning and estimates the number of objects appearing in the image. The recorder 94 records the result of estimating the number of objects appearing in the image.

The trained model used by the estimator 92 may erroneously detect an object from an image. If an object is erroneously detected, the result of estimating the number of objects appearing in the image may be incorrect. For example, in a case in which the trained model outputs the result of estimating the number of objects appearing in the image along with the probability of the result of estimation being correct, the estimator 92 may be configured to adopt the result of estimation if the correctness probability outputted from the trained model is equal to or greater than a threshold, and not adopt the result of estimation if the correctness probability is less than the threshold, instead adopting the result of the user of the image analysis device 90 counting the objects appearing in the image by visual inspection.

However, if the correctness probability outputted by the trained model is incorrect, the number of objects may be estimated erroneously. Demand exists for improving the accuracy of estimating the number of objects. Hereinafter, in the present disclosure, embodiments of an image analysis device 10, and an image analysis method and an image analysis program executed by the image analysis device 10, that can improve the accuracy of estimating attributes of objects, including the number or size of objects, appearing in an image will be illustrated.

### Configuration example of image analysis system 1 according to the present disclosure

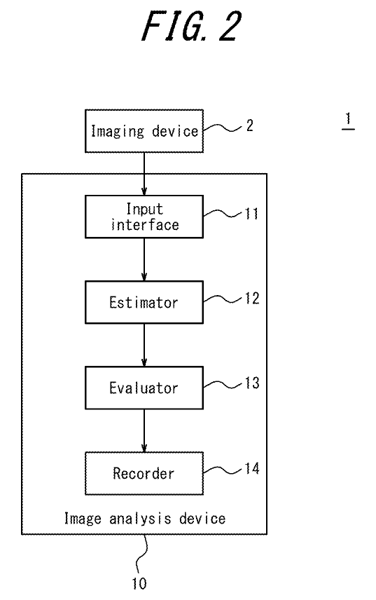

As illustrated in FIG. 2, an image analysis system 1 according to an embodiment of the present disclosure includes an imaging device 2 and an image analysis device 10. The imaging device 2 and the image analysis device 10 are connected to be capable of communicating in a wired or wireless manner. The imaging device 2 and the image analysis device 10 may be connected to be capable of communicating directly or may be connected to be capable of communicating via a network. The imaging device 2 may be included in the image analysis device 10.

In the image analysis system 1, the imaging device 2 images an object contained in a sample and generates an image in which the object appears. The image analysis device 10 acquires the image in which the object appears, detects the object from the image, and estimates attributes of the object, including the number or size of objects appearing in the image. The object may be, for example, a plant, a microorganism or virus, a particle, an oil droplet, or the like. The plants may include algae and the like. The microorganisms may include bacteria, harmful algae, aquatic microorganisms, yeasts, and the like. The particles may include gum particles, protein aggregates, foreign objects, fibrous particles, or the like. The object is not limited to the above-mentioned examples and may be various other bodies. The sample may be a liquid, such as water or a solvent, containing the object.

Below, specific examples of each component of the image analysis system 1 will be described.

### Imaging device 2

The imaging device 2 includes a microscope for observing an object contained in the sample. The microscope includes an optical system that magnifies and images the object. The microscope may be a flow imaging microscope or a fluorescence microscope using laser light but is not limited to these.

The imaging device 2 includes an imaging element that captures an image of an object formed by the microscope. The imaging element may be a charge coupled device image sensor (CCD), a complementary metal oxide semiconductor (CMOS) sensor, or the like.

The imaging device 2 may include a stage that holds the sample within the field of view of the optical system of the microscope. When the sample is a liquid such as water containing the object, the imaging device 2 may include a pipe or a pump for transporting the liquid as the sample to the stage. The imaging device 2 may transport a predetermined amount of liquid at a time as a sample to the stage, capture an image of the object contained in the liquid, and generate an image in which the object appears. The imaging device 2 may generate a plurality of images for one sample. The imaging device 2 may transport the entire amount of liquid as a sample to the stage and image the object. The imaging device 2 may transport only a necessary amount of the total amount of liquid as a sample to the stage and image the object.

### Image analysis device 10

The image analysis device 10 includes an input interface 11, an estimator 12, an evaluator 13, and a recorder 14. The input interface 11 receives an input of an image from the imaging device 2. The estimator 12 estimates an attribute of an object, including the number or size of objects, appearing in the image input to the input interface 11. The evaluator 13 evaluates the validity of the result of estimation, by the estimator 12, of the attribute of the object. The recorder 14 records the estimation result of the attribute of the object when the estimation result is evaluated as being valid by the evaluator 13.

The input interface 11 includes a communication interface that communicably connects to the imaging device 2 in a wired or wireless manner. The communication interface may be configured to be capable of communicating based on, for example, a local area network (LAN) communication standard. The communication interface may be configured to be capable of communicating based on mobile communication standards such as 4^{th} Generation (4G), Long Term Evolution (LTE), or 5^{th} Generation (5G). The input interface 11 may be configured to be capable of communicating based on a serial communication standard such as RS-232C or RS-485. The communication interface is not limited to these examples and may be configured to be capable of communicating based on various communication standards.

The estimator 12 or the evaluator 13 may be configured to include a processor or a dedicated circuit. The processor may be configured to include a central processing unit (CPU) or a graphics processing unit (GPU). The dedicated circuit may be configured to include a field programmable gate array (FPGA) or an application specific integrated circuit (ASIC).

The estimator 12 or the evaluator 13 may be configured to include a storage. The storage may store various information used in the operation of the estimator 12 or the evaluator 13, a program for realizing the functions of the estimator 12 or the evaluator 13, or the like. The storage may function as a working memory for the estimator 12 or the evaluator 13. The memory may be configured to include an electromagnetic storage medium such as a magnetic disk or may be configured to include a memory such as a semiconductor memory or a magnetic memory. The storage may be configured integrally with the estimator 12 or the evaluator 13 or may be configured separately from the estimator 12 or the evaluator 13.

The estimator 12 and the evaluator 13 may be configured as an integrated unit, or may be configured as separate units.

The recorder 14 may be configured to include an electromagnetic storage medium such as a magnetic disk, or may be configured to include a memory such as a semiconductor memory or a magnetic memory. The recorder 14 may be configured integrally with the estimator 12 or the evaluator 13 or may be configured separately from the estimator 12 or the evaluator 13.

The image analysis device 10 may be provided with a display that allows the user of the image analysis device 10 to recognize the estimation result of the attribute of the object. The display may include, for example, but is not limited to, a liquid crystal display (LCD), an organic electroluminescence (EL) display, or an inorganic EL display.

The image analysis device 10 may include an input device for receiving input of operations or data from a user of the image analysis device 10. The input device may, for example, include a keyboard or physical keys, or may include pointing devices such as a touch panel, touch sensor, or mouse. The input device is not limited to these examples and may include a variety of other devices.

The image analysis device 10 may include a controller that controls at least one of the above-described components. The controller may be configured to include a processor or a dedicated circuit. The controller may be configured to include a storage. The controller may be configured integrally with the estimator 12 or the evaluator 13, or may be configured separately from the estimator 12 or the evaluator 13.

The image analysis device 10 may be configured as at least one personal computer (PC) or server. The server may be implemented in an on-premise environment or in a cloud computing environment.

### Example of operation of image analysis device 10

The image analysis device 10 acquires an image in which an object appears from the imaging device 2, estimates an attribute of the object, including the number or size of the object, from the acquired image, evaluates the validity of the estimation result of the attribute of the object, and records the estimation result of the attribute of the object when the estimation result is evaluated as valid.

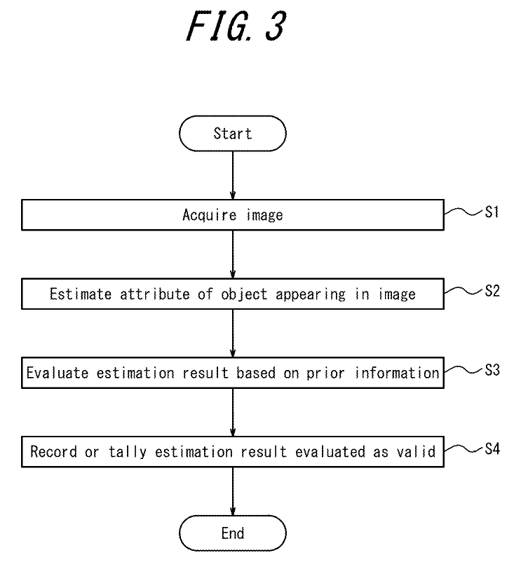

The image analysis device 10 may execute an image processing method including the procedures illustrated in the flowchart of FIG. 3. The procedures illustrated in the flowchart of FIG. 3 may be realized as an image processing program executed by a processor constituting the estimator 12 or the evaluator 13. The image processing program may be stored in a non-transitory computer readable medium such as an electromagnetic storage medium.

The estimator 12 of the image analysis device 10 acquires an image from the imaging device 2 (step S1). The imaging device 2 generates a plurality of images capturing a plurality of objects included in one sample. The estimator 12 may acquire all of the plurality of images generated for one sample. The estimator 12 may acquire only a portion of the images generated for one sample. In a case of acquiring a plurality of images generated by imaging one sample, the estimator 12 may acquire only the number of images corresponding to the amount of sample required to detect the objects contained in the sample.

The estimator 12 estimates an attribute including the number or size of objects appearing in the acquired image using an estimation model (step S2). In a case of acquiring a plurality of images, the estimator 12 may estimate the attributes of the objects appearing in all of the acquired images. The estimator 12 may estimate attributes of objects appearing in a portion of the plurality of acquired images. In the case of acquiring a plurality of images generated by imaging one sample, the estimator 12 may estimate the attributes of the objects appearing in the images for the number of images corresponding to the amount of sample required to detect the objects contained in the sample. The image used as the target of estimation by the estimator 12 is also referred to as a first image to distinguish it from a reserve image, which will be described later.

The estimation model is configured to receive an input of an image, detect objects appearing in the inputted image, and output an estimation result of attributes including the number or size of the objects. The estimation model may be configured to output the result of estimating the position of an object appearing in the inputted image in units of pixels. The estimation model may be configured to output the result of estimating the coordinates of a bounding box that encloses an object appearing in the inputted image. If the bounding box is rectangular, the estimation model may estimate the coordinates of at least two diagonally opposite corners.

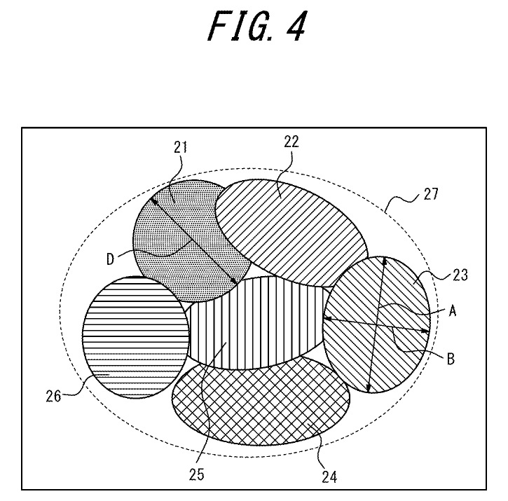

The object appearing in the image may be an aggregate 27 including a plurality of aggregate elements 21 to 26, as illustrated in FIG. 4. The number of aggregate elements contained in one aggregate is not limited to six, but may be five or less, or seven or more. The estimation model may be configured to detect each of a plurality of aggregate elements when an aggregate appears in the image and to output the number of detected aggregate elements as the estimation result. When the image exemplified in FIG. 4 is inputted, the estimation model may detect each of the aggregate elements 21 to 26 and output the detection of six aggregate elements as the estimation result. The estimation model may be configured to output the result of estimating the position of each of the detected aggregate elements 21 to 26 or the coordinates of a bounding box surrounding each of the aggregate elements 21 to 26.

The estimation model may be configured to output a result of estimating at least one of the color or texture of the object as the attribute of the object. By the estimation model estimating the color or texture of the object, the accuracy of detecting individual aggregate elements in the aggregate improves.

The estimation model may include a trained model generated by performing machine learning. Machine learning may be performed using data with correct answers, which is data such that correct answer data for the attributes of objects appearing in an image is associated with the image. Machine learning may be performed using images of objects as data without correct answers. The estimation model may be generated by the estimator 12 or an external device performing machine learning.

The estimation model may include an image processing model. The image processing model may be configured to output an image that is a result of subjecting an inputted image to filtering or threshold processing. The image processing model may include a rule-based model that specifies an algorithm for identifying attributes of objects appearing in an image.

The evaluator 13 of the image analysis device 10 evaluates the validity of the result of estimation, by the estimator 12, of the attribute of the object appearing in the image, based on prior information on the object appearing in the image (step S3).

The evaluator 13 evaluates whether the estimation result is valid by comparing the estimation result of the attribute of the object appearing in the image with the prior information on the object appearing in the image. The evaluator 13 may evaluate whether the estimation result is valid by using an evaluation model generated by incorporating prior information. As will be described later, the evaluator 13 may evaluate the estimation result as valid when the difference between the estimation result and the prior information is less than a threshold.

The evaluator 13 may acquire information about the size of an object that is expected to appear in the image as the prior information. In a case in which the estimation result of the attributes of the object includes the size of the object, the evaluator 13 may evaluate the estimation result of the size of the object as valid if the difference between the size of the object expected to appear in the image and the size of the object estimated to appear in the image is less than a threshold. By including information regarding the size of the object in the prior information, the accuracy of evaluating the validity of the estimation result of the size of the object is improved. As a result, the accuracy of analyzing the objects in the image is improved.

For example, the estimator 12 may erroneously detect the aggregate 27 from the image of FIG. 4 as a single object, and erroneously estimate the size of the object as the size of the aggregate 27. In this case, the evaluator 13 acquires the size of one of the aggregate elements 21 to 26 as prior information and calculates the difference between the size of the aggregate 27 and the size of one of the aggregate elements 21 to 26. Since the difference between the size of the aggregate 27 and the size of one of the aggregate elements 21 to 26 is equal to or greater than a threshold, the evaluator 13 can evaluate the estimation result of the size of the object as invalid.

When the estimation result of the attributes of the objects includes the number of objects, the evaluator 13 may calculate the number of objects that are expected to appear in the image from the prior information and make a comparison with the estimation result. The evaluator 13 may evaluate the estimation result of the number of objects as valid if the difference between the number of objects assumed to appear in the image and the number of objects estimated to appear in the image is less than a threshold.

For example, the estimator 12 may erroneously detect the aggregate 27 in the image of FIG. 4 as one object and erroneously estimate the number of objects as one. In this case, the evaluator 13 acquires the size of any one of the aggregate elements 21 to 26 as prior information and calculates that the number of objects estimated to appear in the image from the size of any one of the aggregate elements 21 to 26 is six. Since the difference between the estimated number of objects and the number of objects expected from the prior information is equal to or greater than a threshold, the evaluator 13 can evaluate the estimation result of the number of objects as invalid.

The information regarding the size of the object may include the diameter (D) of a circle approximating the outer shape of the object, such as the aggregate element 21 in FIG. 4. In a case in which the outer shape of the object, such as the aggregate element 23 in FIG. 4, is approximated by an ellipse, the information about the size of the object may include the major axis (A) and minor axis (B) of the ellipse. The information regarding the size of the object may include the size of a bounding box that surrounds the object.

When an image in which an object appears has been cropped around the object, the size of the image and the size of the object appearing in the image will be substantially the same. When the object is an aggregate containing a plurality of aggregate elements, the size of the image in which the aggregate appears substantially matches the size of the aggregate itself. Additionally, the size of an aggregate can be correlated with the number of aggregate elements contained in the aggregate. Assuming that the area of the aggregate elements illustrated in the image is uniform, the area of the aggregate illustrated in the image is proportional to the number of aggregate elements contained in the aggregate. From the above, it can be seen that the size of an image in which an aggregate appears as an object is proportional to the number of aggregate elements contained in the aggregate.

Therefore, in a case in which the object is an aggregate, the prior information may include the ratio of the number of aggregate elements contained in the aggregate to the size of an image in which the aggregate appears as the object. The evaluator 13 may evaluate the validity of the estimation result of the attribute of the object by comparing the ratio of the number of aggregate elements estimated to appear in the image to the size of the image with prior information.

The prior information may also include the ratio of the number of aggregate elements contained in the aggregate to the size of the aggregate. The evaluator 13 may evaluate the validity of the estimation result of the attribute of the object by comparing the ratio of the number of aggregate elements estimated to appear in the image to the size of the aggregate appearing in the image with prior information.

By the prior information including information regarding the number of aggregate elements, the accuracy of estimating the number of objects appearing in the image is improved. As a result, the accuracy of analyzing the objects in the image is improved.

The evaluator 13 may acquire information regarding the shape of an object that is expected to appear in the image as prior information and evaluate whether the result of detecting the object from the image is valid by comparing the shape of the object detected from the image with the prior information. The evaluator 13 may identify an object appearing in an image based on the position, a bounding box, or a segmentation mask of the object as outputted from the estimation model, and compare the shape of the identified object with prior information. The evaluator 13 may perform pattern matching to determine whether the shape of the identified object matches or substantially matches the shape that is based on the prior information. In a case of determining that the shape of the identified object matches or substantially matches the shape based on the prior information, the evaluator 13 may evaluate the result of detecting the object from the image as valid and may evaluate the estimated result of the attribute of the object appearing in the image as valid. By including information regarding the shape of the object in the prior information, the accuracy of detecting the object from the image is improved. As a result, the accuracy of analyzing the objects in the image is improved.

The information regarding the shape of the object may include a shape that can approximate the outer shape of the object, such as a circle, ellipse, or polygon. The information regarding the shape of the object may include the aspect ratio of a bounding box that encloses the object. The information regarding the shape of the object may include the ratio of the major axis (A) to the minor axis (B) of the ellipse, i.e., the aspect ratio, in a case in which the outer shape of the object is approximated by an ellipse like the aggregate element 23 in FIG. 4. The information about the shape of the object may include the number of sides or vertices of a polygon that approximates the outer shape of the object.

The evaluator 13 may acquire information regarding the color or texture of the object as prior information and evaluate whether the result of detecting the object from the image is valid by comparing the color or texture of the object detected from the image with the prior information. The evaluator 13 may identify an object appearing in an image based on the position or a bounding box of the object as outputted from the estimation model and compare the color or texture of the identified object with prior information. In a case of determining that the color or texture of the identified object matches or substantially matches the color or texture based on the prior information, the evaluator 13 may evaluate the result of detecting the object from the image as valid and may evaluate the estimated result of the attribute of the object appearing in the image as valid. By the prior information including information regarding the color or texture of the object, the accuracy of detecting an object from an image is improved. As a result, the accuracy of analyzing the objects in the image is improved.

The prior information may include information specifying standard values for individual items of the attributes of the object, as described above. The prior information may include information specifying acceptable ranges for individual items of the attributes of the object. The image analysis device 10 may accept input of prior information from a user via an input device. The evaluator 13 may evaluate the validity of the estimation result of the attributes of the object using prior information inputted by the user.

The prior information may be stored in advance in the storage as information that combines the type of object and the value or allowable range of at least one attribute of the object. In this case, the image analysis device 10 may receive an input from the user specifying the type of object. The evaluator 13 may evaluate the validity of the estimation result of the attribute of the object using a standard value or an allowable range of the item corresponding to the type of object specified by the user.

The prior information may be inputted in association with the image when the image is inputted to the input interface 11.

Referring again to FIG. 3, the evaluator 13 records or tallies the estimation results of the attributes of the object that have been evaluated as valid in the procedure of step S3 in the recorder 14 (step S4). The evaluator 13 may record, in the recorder 14, the estimation result that is evaluated as valid in association with the image from which the estimation result was obtained. Among the estimation results of the attributes of the objects appearing in images obtained for one sample, the evaluator 13 may tally the estimation results evaluated as valid as the estimation results of the attributes of the objects contained in that sample.

The evaluator 13 may calculate the total number of objects estimated to appear in each of a plurality of images as the tally of the estimation results of the attribute of the objects. The evaluator 13 may generate a histogram of the sizes of the objects estimated to appear in each of the plurality of images as the tally of the estimation results of the attribute of the objects. The evaluator 13 is not limited to these examples and may execute various other processes to tally the estimation results of the attributes of the objects.

The evaluator 13 discards the estimation results of the attributes of the object that are evaluated as invalid in the procedure of step S3 without recording these estimation results in the recorder 14, thus excluding these estimation results from the tally.

After executing the procedure of step S4, the image analysis device 10 ends the execution of the flowchart of FIG. 3.

### Summary

As described above, the image analysis device 10 according to the present embodiment uses the evaluator 13 to evaluate the validity of the estimation result of the attribute of an object appearing in an image, the attribute being estimated by the estimator 12 using an estimation model. In this way, even if the estimation model erroneously detects an object from an image or erroneously estimates the attributes of an object appearing in the image, the erroneous estimation result is excluded from recording or tallying. By eliminating erroneous estimation results, the accuracy of analysis of an object appearing in the image is improved.

### Other embodiments

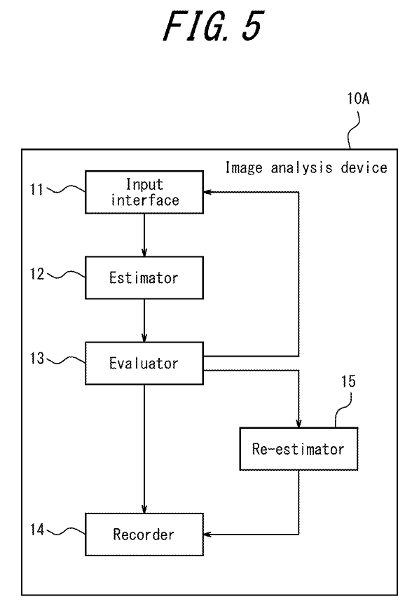

An image analysis device 10A according to another embodiment of the present disclosure will be described with reference to FIG. 5.

In comparison with the image analysis device 10 of FIG. 2, the image analysis device 10A further includes a re-estimator 15. The re-estimator 15 may be configured to include a processor or a dedicated circuit, like the estimator 12 or the evaluator 13. The re-estimator 15 may be configured to include a storage, like the estimator 12 or the evaluator 13.

The operation of the image analysis device 10A differs from the operation of image analysis device 10 in FIG. 2 after the evaluator 13 evaluates that the estimation result of the attribute of the object is invalid.

In the image analysis device 10A, as one of the operations after the evaluator 13 evaluates that the estimation result of the attribute of the object is invalid, the re-estimator 15 redoes the estimation of the attribute of the object. For an image for which the estimation result has been evaluated by the evaluator 13 as being invalid, the re-estimator 15 acquires the result of the user of the image analysis device 10A estimating the attribute of the object appearing in the image. For viewing by the user, the re-estimator 15 may display, on a display, an image for which the estimation result has been evaluated by the evaluator 13 as being invalid, so that the user can estimate the attribute of the object. The re-estimator 15 may receive, from an input device, an input of the result of estimation of the attribute of the object by the user who viewed the image. The re-estimator 15 replaces the estimation result evaluated as invalid by the evaluator 13 with the estimation result by the user and records or tallies the estimation result in the recorder 14.

As another operation performed by the image analysis device 10A after the evaluator 13 has evaluated the estimation result of the attribute of the object as invalid, the image whose estimation result was evaluated as invalid by the evaluator 13 is replaced with a reserve image, and the estimator 12 estimates the attribute of the object appearing in the reserve image. The image before replacement corresponds to the first image. The reserve image after replacement is also called a second image. The reserve image is an image that can replace the first image before replacement and is selected from among images that have not yet been subjected to estimation by the estimator 12 among a plurality of images generated by imaging the same sample as the sample from which the image before replacement was captured. In a case in which any images that can be used as a reserve image remain among the images inputted from the imaging device 2 to the input interface 11, the estimator 12 may select a reserve image from the remaining images. In a case in which any images that can be used as reserve images remain among the images that have not yet been inputted from the imaging device 2 to the input interface 11, the input interface 11 may accept input of images that can be used as reserve images from the imaging device 2, and the estimator 12 may select a reserve image from the input images.

The estimator 12 selects, as a reserve image, an image similar to the image for which the estimation result has been evaluated by the evaluator 13 as invalid. The estimator 12 may determine that images whose size is the same or substantially the same, or whose difference in size is less than a threshold, are similar images. The estimator 12 may determine that an image is similar if the distribution of brightness values of each of the plurality of pixels that constitute the image is the same or substantially the same, or if the difference in the distribution of brightness values is less than a threshold. The estimator 12 may select similar images not only using the distribution of the brightness values of each of the plurality of pixels that constitute the image, but also using the distribution of information such as color information of each of the plurality of pixels that constitute the image, i.e., a histogram of the image. The estimator 12 may determine that images whose features calculated from the images, such as SIFT (Scale-Invariant Feature Transform), are the same or substantially the same, or images whose difference in image features is less than a threshold, are similar images. The estimator 12 may determine that images whose feature vectors, which have a plurality of features as elements, are the same or substantially the same, or images whose difference in feature vectors is less than a threshold, are similar images. The estimator 12 may select similar images using SSIM (Structural Similarity) of the images. SSIM is an index that quantifies the similarity of image structures. The estimator 12 may select similar images using a trained model that selects similar images. The trained model for selecting similar images may be a model generated by performing training using combinations of similar images as correct answer data. The estimator 12 may select similar images using a technique that combines the various determination methods described above.

The image analysis device 10A may replace the estimation result evaluated as invalid by the evaluator 13 with the result of re-estimating the attribute of the object appearing in the reserve image by the estimator 12, and record or tally the result in the recorder 14. The image analysis device 10A may use the evaluator 13 to evaluate the validity of the result of the estimator 12 re-estimating the attribute of the object appearing in the reserve image. In a case in which the evaluator 13 evaluates the estimation result of the attribute of the object appearing in the reserve image as valid, the evaluator 13 may record or tally the estimation result evaluated as valid in the recorder 14.

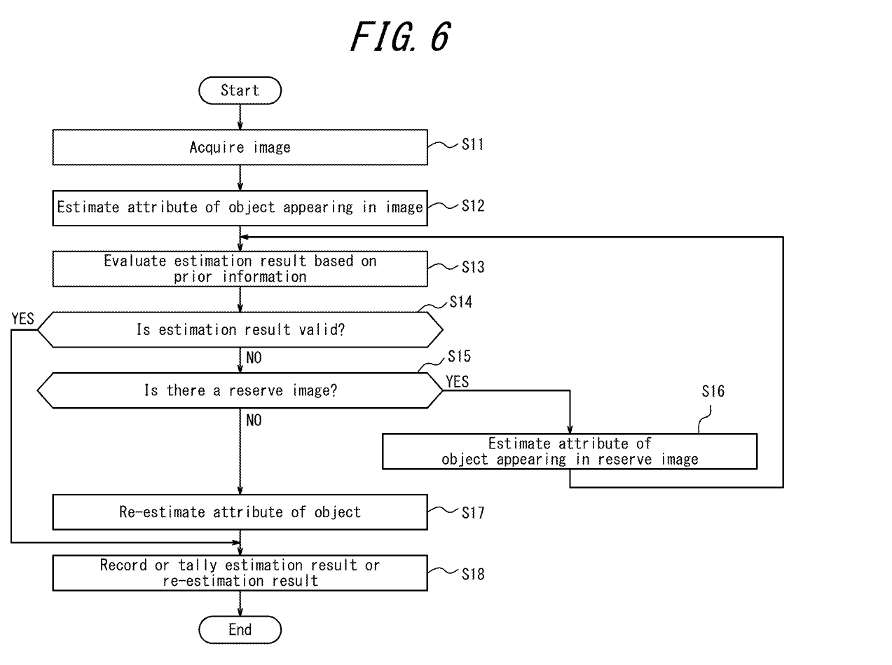

The image analysis device 10A may execute an image processing method including the procedures illustrated in the flowchart of FIG. 6. The procedures illustrated in the flowchart of FIG. 6 may be realized as an image processing program executed by a processor constituting the estimator 12, evaluator 13, re-estimator 15, or controller of the image analysis device 10A. The image processing program may be stored in a non-transitory computer readable medium such as an electromagnetic storage medium.

The estimator 12 acquires an image from the imaging device 2 (step S11). The estimator 12 estimates an attribute including the number or size of objects appearing in the acquired image using an estimation model (step S12). The evaluator 13 evaluates the validity of the result of estimation, by the estimator 12, of the attribute of the object appearing in the image, based on prior information on the object appearing in the image (step S13). The procedure from steps S11 to S13 may be executed in the same manner as the procedure from steps S1 to S3 in the flowchart of FIG. 3.

The evaluator 13 evaluates whether the estimation result of the attribute of the object is valid (step S14). In a case in which the evaluator 13 evaluates that the estimation result of the attribute of the object is valid (step S14: YES), the processing of the image analysis device 10A proceeds to the procedure of step S18, described below.

In a case in which the evaluator 13 evaluates that the estimation result of the attribute of the object is invalid (step S14: NO), the image analysis device 10A determines whether there is a reserve image to use in place of the image whose estimation result was evaluated as invalid (step S15). For example, in the case of images that have not yet been used to estimate the attribute of the object remaining among the plurality of images captured for one sample and acquired from the imaging device 2 by the input interface 11, the estimator 12 may determine whether any of the remaining images can be used as a reserve image. In the case of images that have not yet been acquired by the input interface 11 remaining among the plurality of images captured by the imaging device 2 for one sample, the estimator 12 may acquire, via the input interface 11, new images that have not yet been acquired and determine whether any of the newly acquired images can be used as reserve images. The procedure of step S15 may be executed by the evaluator 13, the re-estimator 15, or the controller.

If it is determined that a reserve image exists (step S15: YES), the estimator 12 estimates the attribute of the object appearing in the reserve image (step S16). The procedure of step S16 may be executed in the same manner as the procedure of step S12. After the estimator 12 executes the procedure of step S16, the image analysis device 10A may return to the procedure of step S13 and use the evaluator 13 to evaluate the estimation result of the attributes of the object appearing in the reserve image.

In a case in which it is determined that there is no reserve image (step S15: NO), the re-estimator 15 performs re-estimation of the attribute of the object appearing in the image for which the estimation result of the attribute of the object was evaluated as invalid (step S17).

The image analysis device 10A records or tallies the estimation result evaluated as valid or the re-estimation result by the re-estimator 15 in the recorder 14 (step S18). Specifically, the evaluator 13 records or tallies the estimation result evaluated as valid in the recorder 14. In a case in which the estimator 12 replaces an image with a reserve image to estimate the attribute of an object, the evaluator 13 may record or tally in the recorder 14 the estimation result evaluated as valid among the estimation results of the attributes of objects appearing in the reserve image. When re-estimation is performed on an image corresponding to an estimation result evaluated as invalid, the re-estimator 15 records or tallies the re-estimation result in the recorder 14. After executing the procedure of step S18, the image analysis device 10A ends the execution of the procedures in the flowchart of FIG. 6.

In a case in which the image analysis device 10A evaluates that the estimation result of the attribute of the object is invalid, the re-estimator 15 may perform re-estimation on the image corresponding to the estimation result evaluated as invalid, regardless of whether a reserve image exists. The image analysis device 10 does not need to perform re-estimation by the re-estimator 15 even when there is no reserve image.

As described above, according to the image analysis device 10A of another embodiment, and the image analysis method and image analysis program executed by the image analysis device 10A, in a case in which the estimation result of the attribute of the object is evaluated as invalid, replacement with a reserve image or re-estimation is performed. With this configuration, even if the estimation results of the attributes of objects appearing in some images captured for a single sample are evaluated as invalid, compensation is made for the lack of images required for recording or tallying the estimation results of the attributes of objects contained in a single sample. As a result, the accuracy of recording or tallying the estimation results of the attributes of the objects contained in the sample is improved.

Although an embodiment of the present disclosure has been described above with reference to the drawings, the specific configuration is not limited to this embodiment, and various modifications that do not deviate from the spirit of the present disclosure are included in the scope thereof.

1. A non-transitory computer readable medium storing an image analysis program configured to cause a processor to:
estimate at least one of a number and a size of an object as an attribute of the object from a first image in which the object appears;
evaluate an estimation result of the attribute of the object based on prior information on the object; and
record or tally the estimation result when the estimation result is evaluated as valid.

2. The non-transitory computer readable medium according to claim 1, wherein the image analysis program causes the processor to
re-estimate the attribute of the object from the first image in a case in which the estimation result of the attribute of the object appearing in the first image is evaluated as invalid; and
record or tally a re-estimation result.

3. The non-transitory computer readable medium according to claim 1, wherein the image analysis program causes the processor, in a case in which the estimation result of the attribute of the object appearing in the first image is evaluated as invalid, to estimate the attribute of the object from a spare second image that can replace the first image.

4. The non-transitory computer readable medium according to claim 1, wherein the prior information on the object includes information regarding a shape or the size of the object.

5. The non-transitory computer readable medium according to claim 1, wherein in a case in which the object is an aggregate including aggregate elements, the prior information on the object includes a ratio between a size of the aggregate and a number of the aggregate elements, or a ratio between a size of the first image and the number of the aggregate elements.

6. The non-transitory computer readable medium according to claim 1, wherein the image analysis program causes the processor to further estimate at least one of a color or a texture of the object as an attribute of the object from the first image.

7. The non-transitory computer readable medium according to claim 6, wherein the prior information on the object includes information regarding the color or the texture of the object.

8. An image analysis method to be executed by a processor, the image analysis method comprising:
estimating at least one of a number and a size of an object as an attribute of the object from a first image in which the object appears;
evaluating an estimation result of the attribute of the object based on prior information on the object; and
recording or tallying an estimation result evaluated as valid.

9. An image analysis device comprising:
an estimator configured to estimate at least one of a number and a size of an object as an attribute of the object from a first image in which the object appears;
an evaluator configured to evaluate an estimation result of the attribute of the object based on prior information on the object, and record or tally the estimation result when the estimation result is evaluated as valid.

10. The image analysis device according to claim 9, further comprising a re-estimator configured to re-estimate the attribute of the object from the first image in a case in which the estimation result of the attribute of the object appearing in the first image is evaluated as invalid, and record or tally a re-estimation result.

11. The image analysis device according to claim 9, wherein in a case in which the estimation result of the attribute of the object appearing in the first image is evaluated as invalid, the estimator estimates the attribute of the object from a spare second image that can replace the first image.
